(19) United States
(12) Patent Application Publication
(10) Pub. No.: US 2026/0303752 A1
(43) Pub. Date: Oct. 1, 2026

(54) IMAGE PROCESSING APPARATUS, CONTROL METHOD, AND STORAGE MEDIUM

(71) Applicant: CANON KABUSHIKI KAISHA, Tokyo (JP)

(72) Inventor: KAZUKI SAMO, Kanagawa (JP)

(21) Appl. No.: 19/574,932

(22) Filed: Mar. 23, 2026

(30) Foreign Application Priority Data
Mar. 31, 2025 (JP) 2025-057895

(51) Int. Cl. H04N 1/60; G09G 5/02; H04N 1/00

(52) U.S. Cl. CPC H04N 1/60; G09G 5/02; H04N 1/0044; G09G 2320/0666; G09G 2340/06

(57) ABSTRACT

An image processing apparatus includes a display control unit configured to display a predetermined screen including an image display region in which image data is displayed, an operation region in which processing is executed on the image data, and a predetermined item to execute processing of changing a tone of the image display region, wherein the display control unit is configured to, based on the predetermined item being operated, change the tone of the image display region and display the image display region in the changed tone.

### BACKGROUND

The present disclosure relates to an image processing apparatus, a control method, and a storage medium.

### Description of the Related Art

In recent years, efforts have been made to introduce a color arrangement design created from a user's standpoint to appropriately convey information with consideration for partial color-blind people (color universal design). For example, Japanese Patent Application Laid-Open No. 2009-15438 proposes a method of providing a mode selection screen to switch a display mode for a partial color-blind person in a system for selecting a print image and accepting an order for the print image.

### SUMMARY

The present disclosure is directed to provision of a method of increasing usability regarding screen display.

According to an aspect of the present disclosure, an image processing apparatus includes a display control unit configured to display a predetermined screen including an image display region in which image data is displayed, an operation region in which processing is executed on the image data, and a predetermined item to execute processing of changing a tone of the image display region, wherein the display control unit is configured to, based on the predetermined item being operated, change the tone of the image display region and display the image display region in the changed tone.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a hardware configuration of an image processing apparatus.

FIG. 2 is a diagram illustrating a software configuration of the image processing apparatus.

FIGS. 3A to 3H are views each illustrating a display example of a display unit.

FIG. 4 illustrates an example of a flowchart for describing standard tone setting change processing.

FIG. 5 illustrates an example of a flowchart for describing screen display processing.

FIG. 6 illustrates an example of a flowchart for describing partial tone setting change processing.

FIGS. 7A to 7J are views each illustrating a display example of the display unit.

FIG. 8 illustrates an example of a flowchart for describing standard tone setting change processing.

FIG. 9 illustrates an example of a flowchart for describing partial tone setting change processing.

FIGS. 10A and 10B are views each illustrating a display example of the display unit.

FIG. 11 illustrates an example of a flowchart for describing screen display processing.

FIGS. 12A to 12D are views each illustrating a display example of the display unit.

### DESCRIPTION OF THE EMBODIMENTS

Favorable embodiments of the present disclosure will be described in detail below with reference to the accompanying drawings. The following embodiments do not limit matters in the present disclosure, and not all combinations of features described in the following embodiments are necessarily essential to a means for solving the issues of the present disclosure. An identical component is denoted by an identical reference number.

### First Embodiment

### Overview

As an image processing apparatus according to a first embodiment, known is a multifunction peripheral (MFP) having a function of scanning and copying a document, a function of receiving and printing print data, and other functions. The MFP executes processing of each function based on setting information that is preliminarily set by a user with a user interface (UI) available on a display device (a display unit and a display panel) included in the MFP or a graphical user interface (GUI) available on a personal computer (PC) connectable to the MFP. Additionally, the MFP has, for example, a preview function of displaying image data read by a scan function or image data to be printed by a print function on the display unit as a preview image before output.

There is a case where color information (tone) displayed on the display panel is hard to be identified for a partial color blind person (person with color blindness, partial color blindness, color vision deficiency, impaired color vision, or the like), which may possibly hamper recognition of information.

Thus, conventionally known is a technique of setting, as a display mode of a display unit, a mode of performing display in a tone used by a partial color blind person (partial color blind person mode), which is different from a mode of performing display in a tone used for a person with normal color vision (normal color vision mode), and allowing a partial color blind person to recognize information as appropriate. However, in a conventional partial color-blind person mode, all information to be displayed on the display unit is generally displayed in the tone for the partial color-blind person. In this case, the preview image to be displayed on the display unit before output is displayed in the tone for the partial color-blind person as described above. As a result, there is a case where the preview image is displayed in a tone different from the tone of a document before execution of scan or a tone of an actually output product, which may possibly reduce usability for the partial color blind person.

Additionally, examples of a conceivable configuration include a configuration of displaying a mode selection screen that accepts selection of a mode of displaying a predetermined region on a predetermined screen in the tone for the person with normal color vision, and displaying the other region in the tone for the partial color blind person. However, in such a configuration, a user has to select the mode after displaying the mode selection screen, which may possibly be troublesome for the user.

To address this, the present embodiment is directed to provision of a technique of performing display to allow for switching of a tone in the predetermined region on the predetermined screen. Specifically, displayed is a predetermined item that makes it possible to change the tone of an image display region in which image data is displayed on the predetermined screen. For example, in a case where the predetermined item is operated in a state where the partial color blind person mode is set in the MFP, display is performed so that the tone of the image display region on the predetermined screen is changed from the tone for the partial color blind person to the tone for the person with normal color vision. Display in a region other than the image display region on the predetermined screen (for example, an operation region to execute processing on image data) is performed in the tone for the partial color blind person as it is.

With this configuration, even in a case where the partial color blind person mode is set in the MFP, it is possible to easily change the tone of the predetermined region on the predetermined screen to the tone for the person with normal color vision, which increases usability for the partial color blind person.

Additionally, displaying the predetermined item on the predetermined screen makes it possible to change the tone of the image display region while visually recognizing the image display region without transition to another screen, which increases usability.

In the present embodiment, the tone for the person with normal color vision is expressed as “normal colors”, and the tone for the partial color blind person is expressed as “reversed colors”.

### Hardware Configuration of Image Processing Apparatus

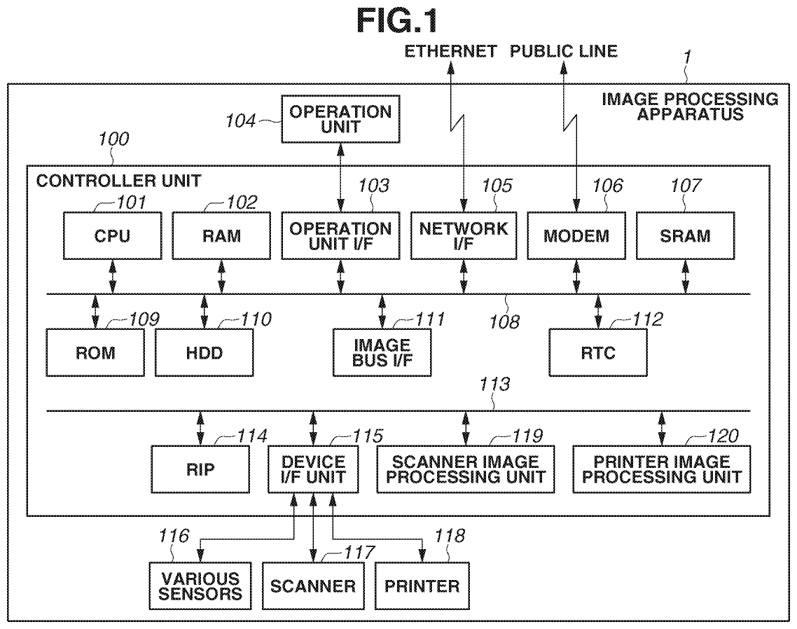

FIG. 1 is a block diagram illustrating a hardware configuration of an image processing apparatus 1 according to the present disclosure.

The image processing apparatus 1 according to the present embodiment is not limited to the above-mentioned MFP, and various kinds of apparatuses such as a personal computer (PC), a smartphone, or a digital camera may be employed as the image processing apparatus according to the present embodiment. Additionally, a print method of a printer to be used in the present embodiment may be an electrophotographic method, an ink-jet method, or another method.

A controller unit 100 is connected to a scanner 117 as an image input device and a printer 118 as an image output device, while it is connected to Ethernet (registered trademark) or a public line, and thereby inputs and outputs image information and device information. A central processing unit (CPU) 101 is a controller that controls the image processing apparatus 1. A random-access memory (RAM) 102 is a system work memory used by the CPU 101 to operate, and is also an image memory to temporarily store image data. A read-only memory (ROM) 109 is a boot ROM, and stores therein a boot program of a system. A hard disk drive (HDD) 110 is a hard disk drive, and stores therein system software, an application, and image data. An operation unit interface (I/F) 103 is an interface unit for an operation unit 104 having a touch panel, and outputs image data displayed on the operation unit 104 to the operation unit 104. Additionally, the operation unit I/F 103 plays a role of conveying information input by a user of the present system to the CPU 101. A network I/F 105 is connected to a network, and inputs and outputs information. A modem 106 is connected to the public line, and inputs and outputs information. A static random-access memory (SRAM) 107 is a non-volatile storage medium capable of performing a high-speed operation. A real time clock (RTC) 112 is a real time clock, and performs processing of continuously counting the current time even in a state where the controller unit 100 is not powered ON. The above-mentioned devices are disposed on a system bus 108. An image bus I/F 111 is a bus bridge that connects the system bus 108 and an image bus 113 that transfers image data at high speed and that converts a data structure. The image bus 113 is configured by a Peripheral Component Interconnect (PCI) bus or Institute of Electrical and Electronics Engineers (IEEE) 1394. The following devices are disposed on the image bus 113. A raster image processor (RIP) 114 is a raster image processor, and develops a page description language (PDL) code into a bit map image.

A device I/F unit 115 is connected to various sensors 116 and acquires a device state. The device I/F unit 115 connects the scanner 117 as the image input device or the printer 118 as the image output device to the controller unit 100, and performs synchronous/asynchronous conversion of image data. A scanner image processing unit 119 corrects, processes, and edits input image data. A printer image processing unit 120 performs correction of the printer 118, resolution conversion, or the like on print output image data.

### Software Configuration of Image Processing Apparatus

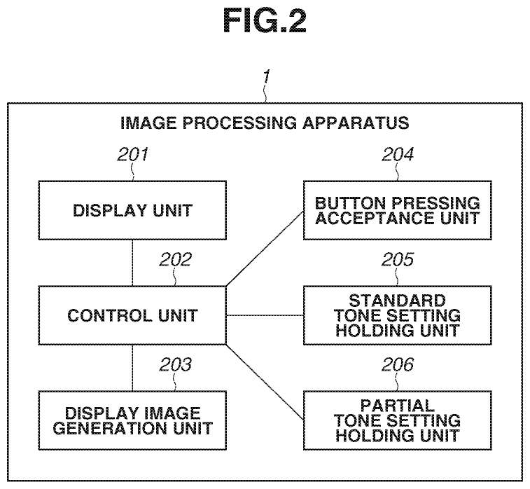

FIG. 2 is a diagram illustrating an example of a software configuration of the image processing apparatus 1.

The image processing apparatus 1 includes a display unit 201, a control unit 202, a display image generation unit 203, a button pressing acceptance unit 204, a standard tone setting holding unit 205, and a partial tone setting holding unit 206. Each of these functional units is implemented by the CPU 101 loading a program installed in the HDD 110 in the RAM 102 with use of the boot ROM of the ROM 109, and executing the program.

The display unit 201 is, out of the above-mentioned operation unit 104, a display that displays information such as screen information. The information to be displayed is controlled by the control unit 202, which will be described below. The display unit 201 is, for example, a touch panel display.

The control unit 202 controls the whole of the system. Specifically, the control unit 202 functions as a display control unit that controls display of an image generated by the display image generation unit 203 on the display unit 201, and updates screen information in response to a user operation notified by the button pressing acceptance unit 204. The display image generation unit 203 and the button pressing acceptance unit 204 will be described below.

The display image generation unit 203 generates an image to be displayed on the display unit 201 based on a standard tone setting held by the standard tone setting holding unit 205 and a partial tone setting held by the partial tone setting holding unit 206. The standard tone setting and the partial tone setting will be described below.

The button pressing acceptance unit 204 accepts a user operation with respect to information displayed on the display unit 201 (for example, a user operation on a display button), and makes notification to the control unit 202.

The standard tone setting holding unit 205 holds the standard tone setting selected by the user.

The partial tone setting holding unit 206 holds the partial tone setting selected by the user.

Here, the standard tone setting held by the standard tone setting holding unit 205 is, as apparatus information, a tone setting for the whole screen in response to a tone change. In contrast, the partial tone setting held by the partial tone setting holding unit 206 is a tone setting for a partial region that is desired to be different in tone from that of the standard tone setting such as a preview image (image display region) 343 (353) on preview screens 340 and 350, which will be described below.

Although it is not essential, the image processing apparatus 1 may include an authentication unit (not illustrated). The authentication unit manages account information for each user and a login/logout state of the image processing apparatus 1. Here, the authentication unit and the standard tone setting holding unit 205 may be configured to operate in collaboration to allow for holding the standard tone setting for each account.

### Operation Screen

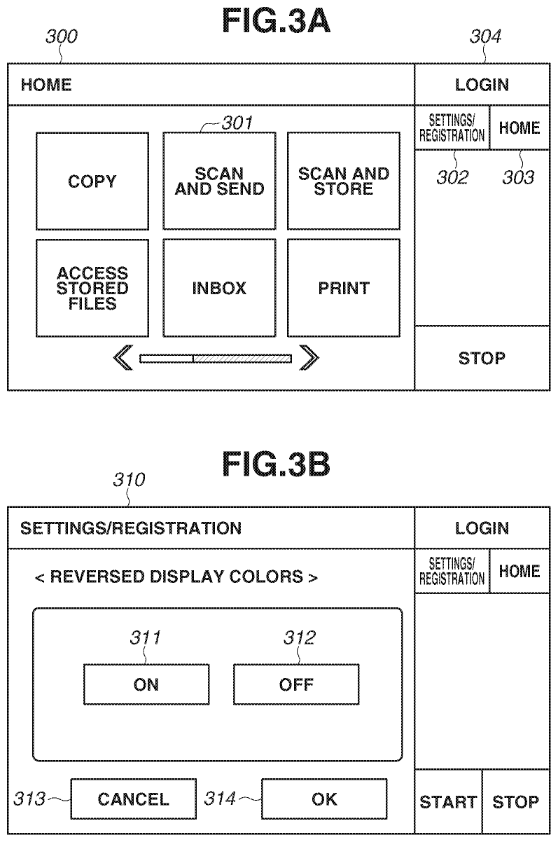

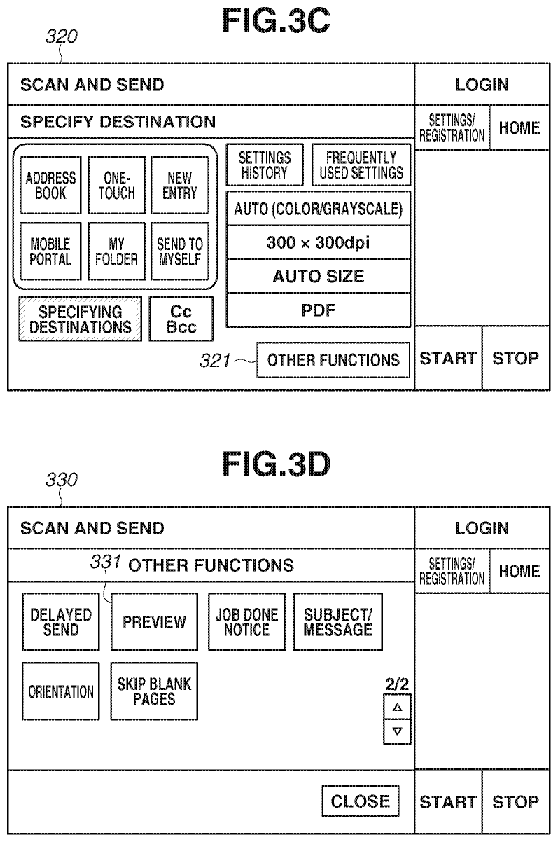

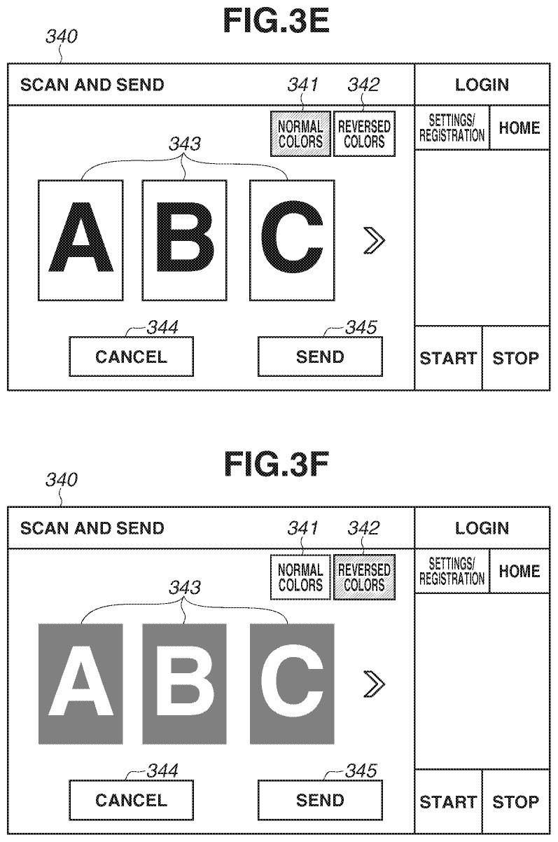

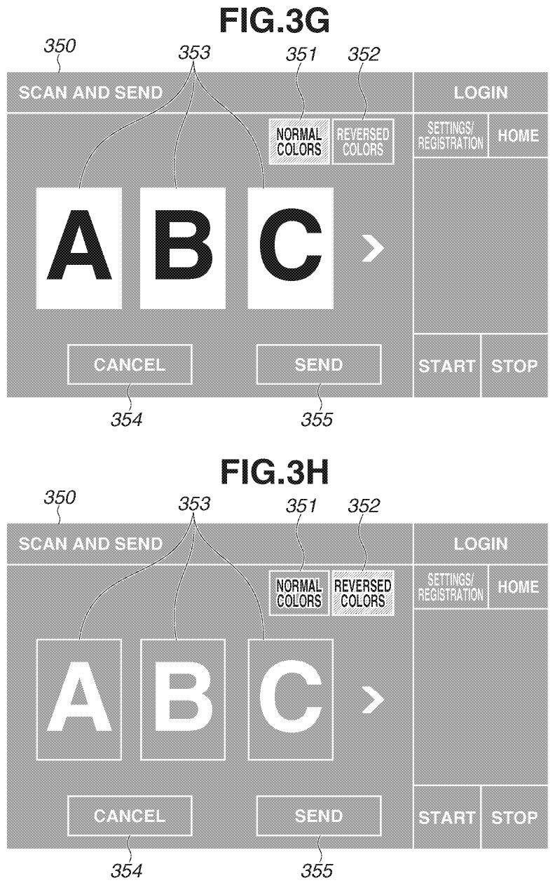

FIGS. 3A to 3H are views each illustrating an example of a screen displayed on the display unit 201 in the image processing apparatus 1.

FIG. 3A is a view illustrating an example of a home screen 300. The home screen 300 is a basic screen of the display unit 201 and is a screen to be displayed after start-up, after auto-clear processing in a case where there is no operation for a certain period of time, in a case where a home button 303 that is displayed also in other screens is pressed, or other cases. An application button (for example, a scan and send button 301) corresponding to each function provided by the image processing apparatus 1 is disposed on the home screen 300. Additionally, a setting/registration button 302, a home button 303, a login button 304, and the like are disposed as buttons to be shared by other screens. In the present embodiment, a description will be given of screen transition of a screen to be displayed by an operation on an application for a “scan and send” function. However, this is merely an example, and it is sufficient if an application is configured to display image data and may be another application. For example, the present embodiment may be applied to a configuration of displaying a preview image before execution of copy. The scan and send function is a function of sending image data of a scanned document to a storage region of an external apparatus, a mail server, a cloud service, or the like. When the scan and send button 301 is operated (pressed), a scan and send screen 320 (FIG. 3C) is displayed on the display unit 201. When the setting/registration button 302 is pressed by the user, a setting/registration screen (not illustrated) is displayed on the display unit 201. Additionally, when each item button on the setting/registration screen is pressed by the user, a setting screen for each setting item (for example, a standard tone setting screen 310, which will be described below) is displayed. The home button 303 cannot be pressed by the user in a state where the home screen 300 is displayed. When the user presses the home button 303 in a state where another screen is displayed, the home screen 300 is displayed. When the login button 304 is pressed by the user, an authentication screen (not illustrated) is displayed on the display unit 201.

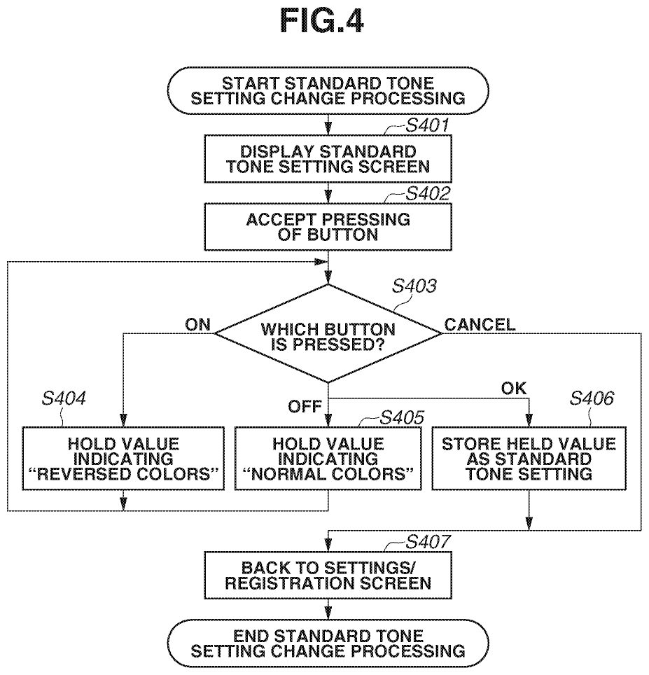

FIG. 3B is a view illustrating an example of the standard tone setting screen 310. An ON button 311 for reversing screen colors, an OFF button 312 for reversing the screen colors, a cancel button 313, and an OK button 314 are disposed on the standard tone setting screen 310. The standard tone setting change processing on the standard tone setting screen 310 is executed by the flowchart in FIG. 4, which will be described below.

FIG. 3C is a view illustrating an example of a scan and send screen 320. Setting information regions (buttons) regarding various kinds of “scan and send” functions are disposed on the scan and send screen 320. Additionally, it is possible to set settings that do not exist on the scan and send screen 320 on an other functions screen 330 to be displayed by pressing of an other functions button 321.

FIG. 3D is a view illustrating an example of the other functions screen 330. Buttons for making various kinds of settings (for example, a preview setting button 331) are disposed on the other functions screen 330. When the preview setting button 331 is pressed by the user, display of the preview setting button 331 changes into yellow light display indicating an ON state of a preview setting. In a case where the scan and send function is executed in a state where the preview setting is ON, the preview screen 340 or the preview screen 350 is displayed at the time of completion of scan processing. That is, the preview screen 340 or the preview screen 350 for displaying a preview of image data of a document read (scanned) by the reading unit of the MFP is displayed.

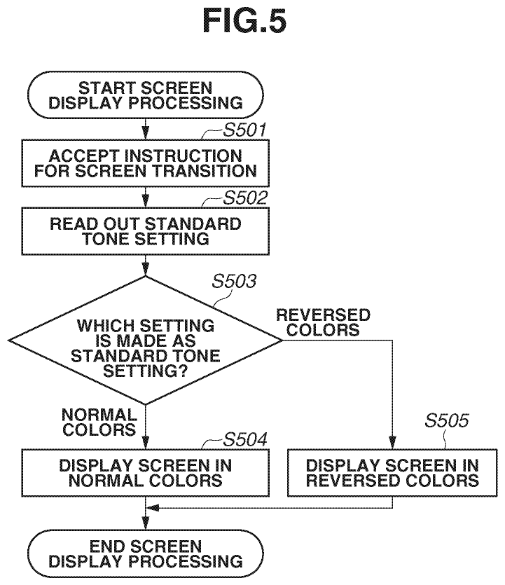

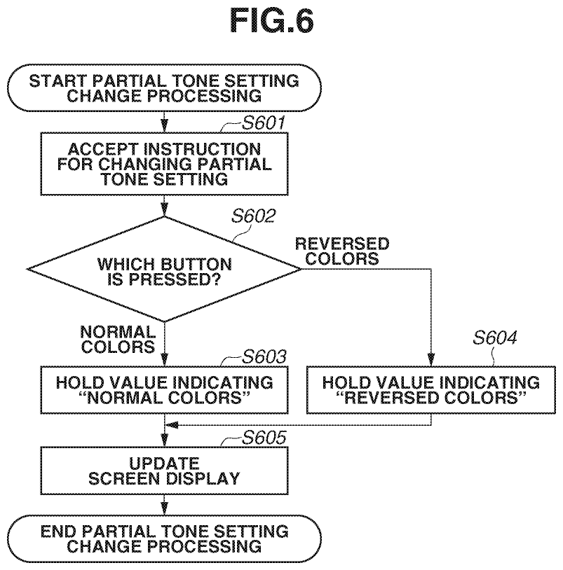

FIGS. 3E and 3F are views each illustrating an example of the preview screen 340 in the “scan and send” application. The preview screen 340 is a preview screen displayed in a case where normal colors are set in the standard tone setting in accordance with the flowchart in FIG. 5. FIG. 3E illustrates an example of a preview screen displayed in a case where a normal colors button 341 is selected. FIG. 3F illustrates an example of a preview screen displayed in a case where a reversed colors button 342 is selected. Partial tone setting change buttons (the normal colors button 341 and the reversed colors button 342), a preview image 343, a cancel button 344, and a send button 345 are disposed on the preview screen 340. In the present embodiment, assume that “normal colors” mentioned herein represent colors of an original image to be displayed as they are, and “reversed colors” mentioned herein represent colors that are reversed by the display image generation unit 203 from the colors of the original image to be displayed. When the normal colors button 341 or the reversed colors button 342 is pressed, a tone of the preview image 343 is changed in accordance with the flowchart in FIG. 6. Assume that the user's pressing of the normal colors button 341 and the reversed colors button 342 is not accepted in a case where the normal colors button 341 or the reversed colors button 342 corresponds to a tone being selected. For example, in a display state illustrated in FIG. 3E, the normal colors button 341 is in a selected display mode (for example, white text on a gray background), and the user's operation on the normal colors button 341 is not accepted at this time. As another method, the normal colors button 341 and the reversed colors button 342 may be hidden in a case where the normal colors button 341 or the reversed colors button 342 corresponds to the tone being selected. When the cancel button 344 is pressed by the user, a “scan and send” job in processing is canceled, and the scan and send screen 320 is displayed on the display unit 201. Meanwhile, when the send button 345 is pressed by the user, the preview screen 340 is closed, and sending of the “scan and send” job is started.

FIGS. 3G and 3H are views each illustrating an example of the preview screen 350. The preview screen 350 is a preview screen displayed in a case where the reversed colors are set in the standard tone setting in accordance with the flowchart in FIG. 5. FIG. 3G illustrates an example of a preview screen displayed in a case where a normal colors button 351 is selected. FIG. 3H illustrates an example of a preview screen displayed in a case where a reversed colors button 352 is selected. The normal colors button 351, the reversed colors button 352, the preview image 353, a cancel button 354, and a send button 355 are disposed on the preview screen 350, similarly to the preview screen 340. Assume that the user's pressing of the normal colors button 351 and the reversed colors button 352 is not accepted in a case where the normal colors button 351 or the reversed colors button 352 corresponds to a tone being selected. As another method, the normal colors button 351 and the reversed colors button 352 may be hidden in a case where the normal colors button 351 or the reversed colors button 352 corresponds to the tone being selected. When the cancel button 354 is pressed by the user, a “scan and send” job in processing is canceled, and the scan and send screen 320 is displayed on the display unit 201. When the send button 355 is pressed by the user, the preview screen 350 is closed, and sending of the “scan and send” job is started.

### Standard Tone Setting Change Processing

FIG. 4 illustrates an example of a flowchart of the standard tone setting change processing on the standard tone setting screen 310. The processing in the flowchart is started based on an instruction for displaying the standard tone setting screen 310 being given. Each of the subsequent steps in the flowchart is implemented by execution of a program by the CPU 101 in the image processing apparatus 1. The program to be executed is read from the ROM 109 and executed by each functional unit illustrated in FIG. 2.

In step S401, the CPU 101 displays the standard tone setting screen 310. The CPU 101 displays either the ON button 311 or the OFF button 312 in a selected state (for example, displays the selected button in yellow) in accordance with a value held by the standard tone setting holding unit 205. Additionally, the control unit 202 holds the value held by the standard tone setting holding unit 205 as a standard tone setting candidate value. The standard tone setting candidate value mentioned herein is a value temporarily held by the control unit 202 without being held by the standard tone setting holding unit 205 until the OK button 314 is pressed while the standard tone setting screen 310 is displayed. Thereafter, the processing proceeds to step S402.

In step S402, the CPU 101 accepts the user's pressing of a button. In a case where the CPU 101 accepts the user's pressing of the button, the processing proceeds to step S403.

In step S403, the CPU 101 determines which button is pressed by the user in step S402. In a case where the CPU 101 determines that the button pressed by the user is the ON button 311 (ON in step S403), the processing proceeds to step S404. In a case where the CPU 101 determines that the button pressed by the user is the OFF button 312 (OFF in step S403), the processing proceeds to step S405. In a case where the CPU 101 determines that the button pressed by the user is the cancel button 313 (CANCEL in step S403), the processing proceeds to step S407. In a case where the CPU 101 determines that the button pressed by the user is the OK button 314 (OK in step S403), the processing proceeds to step S406.

In step S404, the CPU 101 holds the value indicating “reversed colors” as the standard tone setting candidate value, and brings the ON button 311 into a selected state. Thereafter, the processing proceeds to step S403.

In step S405, the CPU 101 holds the value indicating “normal colors” as the standard tone setting candidate value, and brings the OFF button 312 into a selected state. Thereafter, the processing proceeds to step S403.

In step S406, the CPU 101 stores the standard tone setting candidate value as the value held by the standard tone setting holding unit 205 (the standard tone setting). Specifically, the CPU 101 overwrites the value held by the standard tone setting holding unit 205 with the standard tone setting candidate value held in step S404 or S405 and stores the overwritten value.

In step S407 subsequent to processing in step S406 or in the case where the CPU 101 determines that “CANCEL” is selected in step S403, the CPU 101 closes (hides) the standard tone setting screen 310, and displays the settings/registration screen (not illustrated). Thereafter, the CPU 101 ends the processing in the flowchart.

### Screen Display Processing

FIG. 5 is a flowchart of screen display processing on each screen. The processing in the flowchart is started based on an instruction for screen transition being accepted in step S501. Each of the subsequent steps in the flowchart is implemented by execution of a program by the CPU 101 in the image processing apparatus 1. The program to be executed is read from the ROM 109 and executed by each functional unit illustrated in FIG. 2.

In step S501, the CPU 101 accepts the instruction for screen transition. The instruction for screen transition may be given by the user's pressing of a button or a change in state of the image processing apparatus 1 (for example, completion of scan processing).

In step S502, the CPU 101 reads out the value held by the standard tone setting holding unit 205.

In step S503, the CPU 101 determines whether the value read out in step S502 is a value indicating “normal colors” or a value indicating “reversed colors”. In a case where the CPU 101 determines that the readout value is the value indicating “normal colors” (NORMAL COLORS in step S503), the processing proceeds to step S504. In a case where the CPU 101 determines that the readout value is the value indicating “reversed colors” (REVERSED COLORS in step S503), the processing proceeds to step S505.

In step S504, the CPU 101 displays the screen in “normal colors”. For example, in a case of a preview screen of the “scan and send” application, the CPU 101 displays the preview screen 340 illustrated in FIG. 3E, and ends the processing of the flowchart. The normal colors are maintained as the partial tone setting for the preview image, and the CPU 101 displays the screen in a state where the normal colors button 341 is selected.

In step S505, the CPU 101 displays the screen in “reversed colors”. For example, in a case of a preview screen of the “scan and send” application, the CPU 101 displays the preview screen 350 illustrated in FIG. 3H, and ends the processing of the flowchart. The reversed colors are maintained as the partial tone setting for the preview image, and the CPU 101 displays the screen in a state where the reversed colors button 352 is selected.

### Partial Tone Setting Change Processing

FIG. 6 illustrates an example of a flowchart of the partial tone setting change processing on the preview screens 340 and 350. The processing in the flowchart is started based on an instruction for changing the partial tone setting being accepted in step S601. Each of the subsequent steps in the flowchart is implemented by execution of a program by the CPU 101 in the image processing apparatus 1. The program to be executed is read from the ROM 109 and executed by each functional unit illustrated in FIG. 2.

In step S601, the CPU 101 accepts the instruction for changing the partial tone setting. Specifically, the instruction for changing the partial tone setting is given by the user's pressing of the normal colors button 341 (351) or the reversed colors button 342 (352).

In step S602, the CPU 101 determines which button is pressed by the user. In a case where the CPU 101 determines that the pressed button is the “normal colors button 341” (NORMAL COLORS in step S602), the processing proceeds to step S603. In a case where the CPU 101 determines that the pressed button is the “reversed colors button 342” (REVERSED COLORS in step S602), the processing proceeds to step S604.

In step S603, the CPU 101 holds the value indicating “normal colors” as the value (partial tone setting) held by the partial tone setting holding unit 206. Thereafter, the processing proceeds to step S605.

In step S604, the CPU 101 holds the value indicating “reversed colors” as the value (partial tone setting) held by the partial tone setting holding unit 206. Thereafter, the processing proceeds to step S605.

In step S605, the CPU 101 causes the control unit 202 to update selection states of the partial tone setting change buttons based on the partial tone setting held in step S603 or S604. Additionally, the display image generation unit 203 changes the tone of the preview image 343 (353) and displays the preview image 343 (353) in the changed tone on the display unit 201. For example, in a case where the “reversed colors button 342” is pressed on the preview screen 340 in FIG. 3E, the CPU 101 holds the value indicating “reversed colors” as the partial tone setting in step S604, and the processing proceeds to step S605, the CPU 101 displays the preview screen 340 illustrated in FIG. 3F in step S605. In a case where the “normal colors button 341” is pressed on the preview screen 340 in FIG. 3F, the CPU 101 holds the value indicating “normal colors” as the partial tone setting in step S603, and the processing proceeds to step S605, the CPU 101 displays the preview screen 340 illustrated in FIG. 3E in step S605. Similarly, in a case where the “reversed colors button 352” is pressed on the preview screen 350 in FIG. 3G, the CPU 101 holds the value indicating “reversed colors” as the partial tone setting in step S604, and the processing proceeds to step S605, the CPU 101 displays the preview screen 350 illustrated in FIG. 3H in step S605. In a case where the “normal colors button 351” is pressed on the preview screen 350 in FIG. 3H, the CPU 101 holds the value indicating “normal colors” as the partial tone setting in step S603, and the processing proceeds to step S605, the CPU 101 displays the preview screen 350 illustrated in FIG. 3G in step S605. Thereafter, the CPU 101 ends the processing in the flowchart.

As described above, in the present embodiment, provided is the technique of performing display to allow for switching of a tone in the predetermined region on the predetermined screen. Specifically, displayed are predetermined items (the normal colors button 351 and the reversed colors button 352) that make it possible to change the tone of an image display region in which image data is displayed on the preview screen. For example, in a case where the predetermined item (the normal colors button 351) is operated in a state where the “reversed colors” are set as the standard tone setting in the MFP, display is performed so that the tone of the image display region on the preview screen is changed from the tone for the partial color blind person to the tone for the person with normal color vision. Display in a region (for example, an operation region to execute processing on image data) other than the image display region on the preview screen is performed in the tone for the partial color blind person as it is.

With this configuration, even in a case where the “reversed colors” (the tone for the partial color blind person) are set as the standard tone setting in the MFP, it is possible to easily change the tone of the image display region on the preview screen to the tone for the person with normal color vision. This makes it easy to compare and check a document before execution of scan or a product to be actually output with a preview image and increases usability for the partial color blind person.

Additionally, displaying the predetermined item on the predetermined screen makes it possible to change the tone of the image display region while visually recognizing the image display region without transition to another screen, which increases usability.

### Second Embodiment

In the first embodiment, the description has been given of the example in which the tone setting is switchable between “normal colors” and “reversed colors”. However, there is a plurality of color vision types. Examples of known color vision types include type 1 color vision with which red is difficult to see, type 2 color vision with which green is difficult to see, and type 3 color vision with which blue is difficult to see.

In a second embodiment, a description will be given of an example in which three or more tone types can be set and changed as a tone in the standard tone setting and a tone in the partial tone setting.

Since configurations and processing not mentioned below are equivalent to those of the first embodiment, a description thereof is omitted.

### Operation Screen

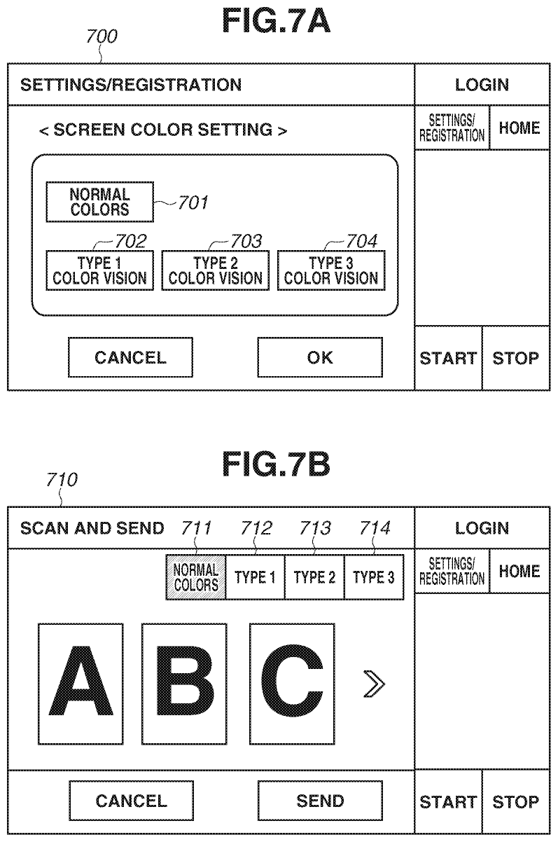

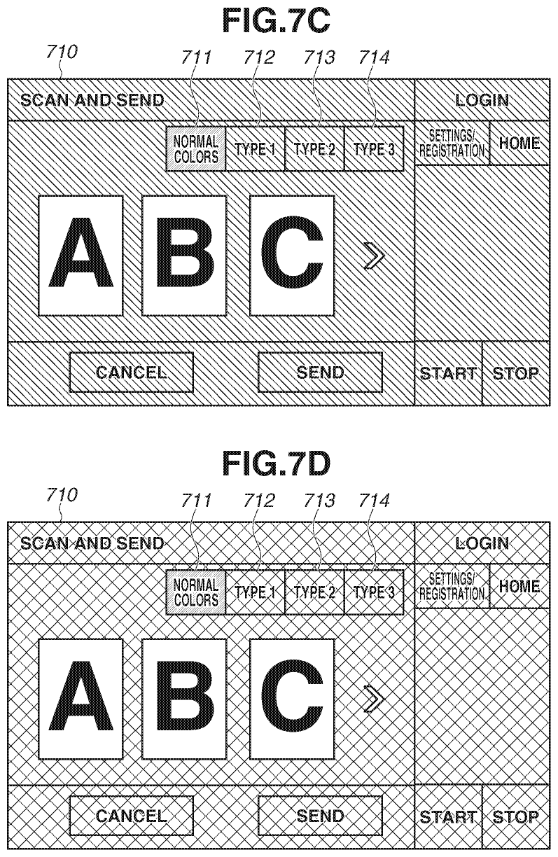

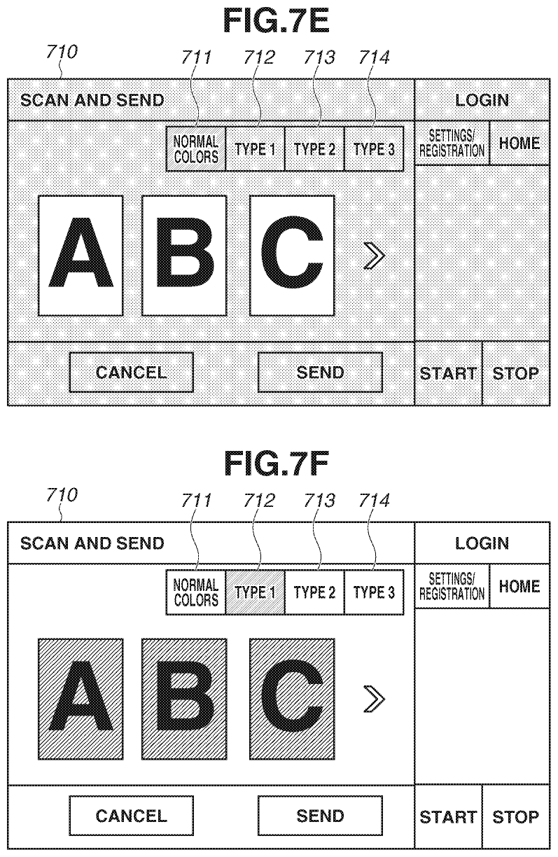

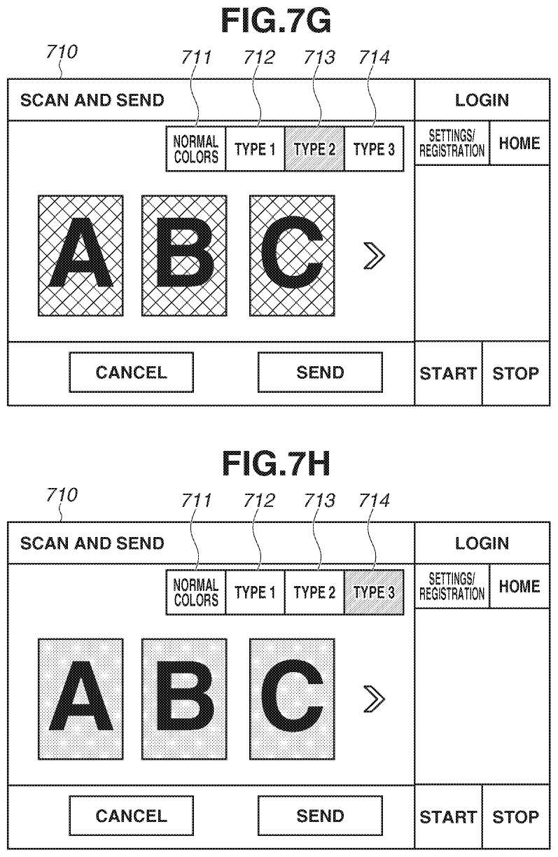

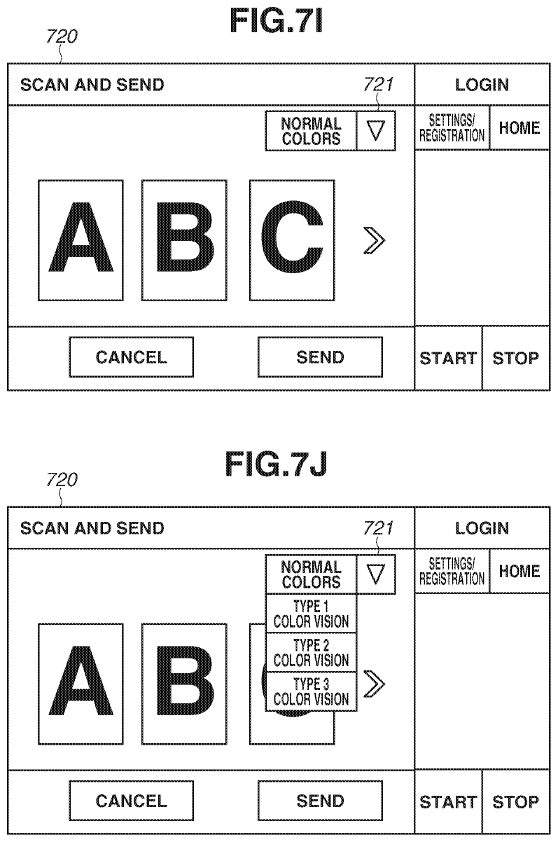

FIGS. 7A to 7J are views each illustrating an example of a screen displayed on the display unit 201 in the image processing apparatus 1 according to the second embodiment.

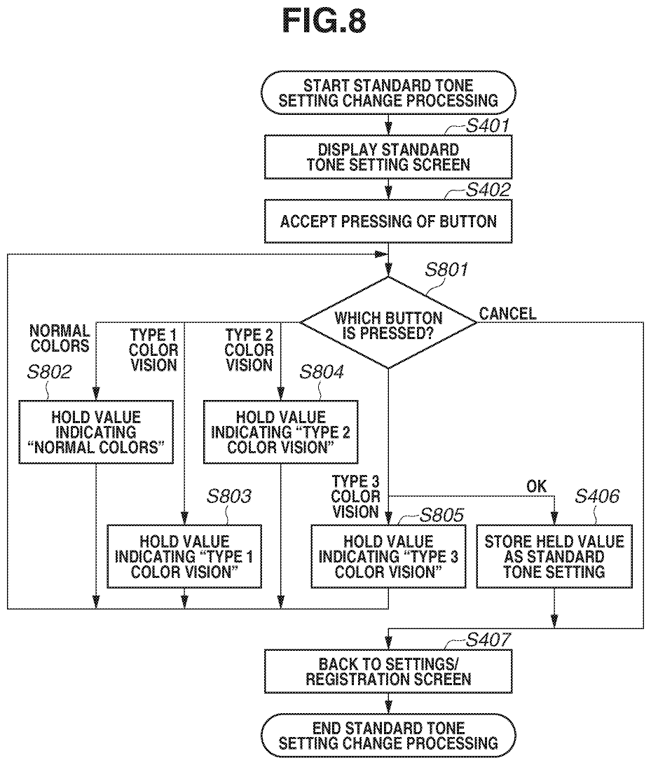

FIG. 7A is a view illustrating an example of a standard tone setting screen 700. A normal colors button 701, a type 1 color vision button 702, a type 2 color vision button 703, and a type 3 color vision button 704 are disposed on the standard tone setting screen 700. The standard tone setting change processing on the standard tone setting screen 700 is executed in accordance with a flowchart in FIG. 8, which will be described below.

FIGS. 7B to 7J are views each illustrating an example of a preview screen 710 in the “scan and send” application.

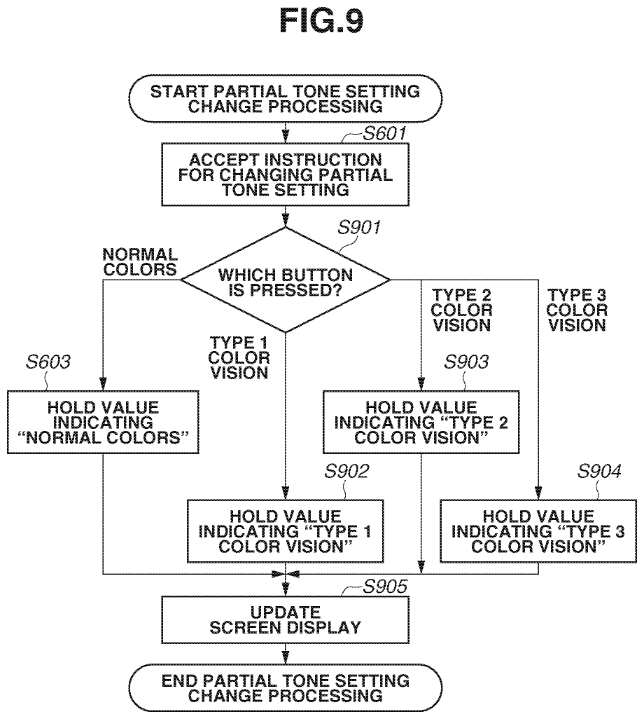

FIG. 7B is a view illustrating an example of the preview screen 710 displayed in a case where the value indicating “normal colors” is set in the standard tone setting and the value indicating “normal colors” is set in the partial tone setting. A normal colors button 711, a type 1 color vision button 712, a type 2 color vision button 713, and a type 3 color vision button 714 are disposed on the preview screen 710. When any of the normal colors button 711, the type 1 color vision button 712, the type 2 color vision button 713, and the type 3 color vision button 714 is pressed by the user, the partial tone setting change processing is executed in accordance with a flowchart in FIG. 9.

FIGS. 7C to 7H are views each illustrating an example in a case where the standard tone setting or the partial tone setting on the preview screen 710 is different from that in FIG. 7B. FIG. 7C is a view illustrating an example of the preview screen 710 displayed in a case where the value indicating “type 1 color vision” is set in the standard tone setting and the value indicating “normal colors” is set in the partial tone setting. FIG. 7D is a view illustrating an example of the preview screen 710 displayed in a case where the value indicating “type 2 color vision” is set in the standard tone setting and the value indicating “normal colors” is set in the partial tone setting. FIG. 7E is a view illustrating an example of the preview screen 710 displayed in a case where the value indicating “type 3 color vision” is set in the standard tone setting and the value indicating “normal colors” is set in the partial tone setting. FIG. 7F is a view illustrating an example of the preview screen 710 displayed in a case where the value indicating “normal colors” is set in the standard tone setting and the value indicating “type 1 color vision” is set in the partial tone setting. FIG. 7G is a view illustrating an example of the preview screen 710 displayed in a case where the value indicating “normal colors” is set in the standard tone setting and the value indicating “type 2 color vision” is set in the partial tone setting. FIG. 7H is a view illustrating an example of the preview screen 710 displayed in a case where the value indicating “normal colors” is set in the standard tone setting and the value indicating “type 3 color vision” is set in the partial tone setting. FIG. 7C illustrates an example of the preview screen 710 displayed in a case where the value indicating “normal colors” is set in the partial tone setting, and the value indicating “type 1 color vision” is set in the standard tone setting. FIG. 7D illustrates an example of the preview screen 710 displayed in a case where the value indicating “normal colors” is set in the partial tone setting, and the value indicating “type 2 color vision” is set in the standard tone setting. FIG. 7E illustrates an example of the preview screen 710 displayed in a case where the value indicating “normal colors” is set in the partial tone setting, and the value indicating “type 3 color vision” is set in the standard tone setting. However, the preview screen 710 is not limited thereto. A corresponding preview screen 710 is displayed also in a case where any of the value indicating “type 1 color vision”, the value indicating “type 2 color vision”, and the value indicating “type 3 color vision” is set in the standard tone setting, and any of the value indicating “type 1 color vision”, the value indicating “type 2 color vision”, and the value indicating “type 3 color vision” is set in the partial tone setting. Specifically, in a case where the value indicating “type 1 color vision” is set in the standard tone setting and the value indicating “type 1 color vision” is set in the partial tone setting, displayed is the preview screen 710 that combines a region other than the image display region illustrated in FIG. 7C and the image display region illustrated in FIG. 7F. That is, in FIGS. 7C to 7H, displayed is the preview screen 710 that combines hatching indicating a tone of the region other than the image display region in which the standard tone setting is reflected and hatching indicating a tone of the image display region in which the partial tone setting is reflected. Similarly, FIG. 7F illustrates an example of the preview screen 710 displayed in a case where the value indicating “normal colors” is set in the standard tone setting, and the value indicating “type 1 color vision” is set in the partial tone setting. FIG. 7G illustrates an example of the preview screen 710 displayed in a case where the value indicating “normal colors” is set in the standard tone setting, and the value indicating “type 2 color vision” is set in the partial tone setting. FIG. 7H illustrates an example of the preview screen 710 displayed in a case where the value indicating “normal colors” is set in the standard tone setting, and the value indicating “type 3 color vision” is set in the partial tone setting. However, the preview screen 710 is not limited thereto. For example, a corresponding preview screen 710 is displayed also in a case where any of the value indicating “type 1 color vision”, the value indicating “type 2 color vision”, and the value indicating “type 3 color vision” is set in the standard tone setting, and any of the value indicating “type 1 color vision”, the value indicating “type 2 color vision”, and the value indicating “type 3 color vision” is set in the partial tone setting.

FIGS. 7I and 7J are views each illustrating an example of a preview screen 720, which is another pattern of the preview screen 710. On the preview screen 720, a partial tone setting selection pull-down menu 721 is disposed in substitution for the normal colors button 711, the type 1 color vision button 712, the type 2 color vision button 713, and the type 3 color vision button 714 on the preview screen 710. When the partial tone setting selection pull-down menu 721 is pressed by the user, “NORMAL COLORS”, “TYPE 1 COLOR VISION”, “TYPE 2 COLOR VISION”, and “TYPE 3 COLOR VISION” are displayed as options (FIG. 7J). In a case where any of the options in the partial tone setting selection pull-down menu 721 is pressed, partial tone setting change processing is executed in accordance with the flowchart in FIG. 9.

### Standard Tone Setting Change Processing

FIG. 8 illustrates an example of a flowchart of the standard tone setting change processing on the standard tone setting screen 700. The processing in the flowchart is started based on an instruction for displaying the standard tone setting screen 700 being given. Each of the subsequent steps in the flowchart is implemented by execution of a program by the CPU 101 in the image processing apparatus 1. The program to be executed is read from the ROM 109 and executed by each functional unit illustrated in FIG. 2. The processing in steps S401, S402, S406, and S407 is similar to that in FIG. 4, and thus a description thereof is omitted.

In step S801, the CPU 101 determines which button is pressed by the user in step S402. In a case where the CPU 101 determines that the button pressed by the user is the “normal colors button 701 (NORMAL COLORS in step S801), the processing proceeds to step S802. In a case where the CPU 101 determines that the button pressed by the user is the “type 1 color vision button 702” (TYPE 1 COLOR VISION in step S801), the processing proceeds to step S803. In a case where the CPU 101 determines that the button pressed by the user is the “type 2 color vision button 703” (TYPE 2 COLOR VISION in step S801), the processing proceeds to step S804. In a case where the CPU 101 determines that the button pressed by the user is the “type 3 color vision button 704” (TYPE 3 COLOR VISION in step S801), the processing proceeds to step S805. In a case where the CPU 101 determines that the button pressed by the user is the cancel button 313 (CANCEL in step S801), the processing proceeds to step S407. In a case where the CPU 101 determines that the button pressed by the user is the “OK button 314” (OK in step S801), the processing proceeds to step S406.

In step S802, the CPU 101 holds the value indicating “normal colors” as the standard tone setting candidate value, and brings the normal colors button 701 into a selected state. Thereafter, the processing proceeds to step S801.

In step S803, the CPU 101 holds the value indicating “type 1 color vision” as the standard tone setting candidate value, and brings the type 1 color vision button 702 into a selected state. Thereafter, the processing proceeds to step S801.

In step S804, the CPU 101 holds the value indicating “type 2 color vision” as the standard tone setting candidate value, and brings the type 2 color vision button 703 into a selected state. Thereafter, the processing proceeds to step S801.

In step S805, the CPU 101 holds the value indicating “type 3 color vision” as the standard tone setting candidate value, and brings the type 3 color vision button 704 into a selected state. Thereafter, the processing proceeds to step S801.

Thereafter, the CPU 101 starts the flowchart in FIG. 5 based on the instruction for screen transition being accepted in step S501 in FIG. 5. Specifically, in step S503, the CPU 101 determines which of the value indicating “normal colors”, the value indicating “type 1 color vision”, the value indicating “type 2 color vision”, and the value indicating “type 3 color vision” the value read out in step S502 is. In a case where the CPU 101 determines that the readout value is the value indicating “normal colors” (NORMAL COLORS in step S503), the processing proceeds to step S504. In a case where the CPU 101 determines that the readout value is any of the value indicating “type 1 color vision”, the value indicating “type 2 color vision”, and the value indicating “type 3 color vision” (TYPE 1 COLOR VISION, TYPE 2 COLOR VISION, or TYPE 3 COLOR VISION in step S503), the processing proceeds to step S505.

In step S504, the CPU 101 displays the screen in “normal colors”. For example, in a case of a preview screen of the “scan and send” application, the CPU 101 displays the preview screen 710 illustrated in FIG. 7B, and ends the processing of the flowchart. The normal colors are maintained as the partial tone setting for the preview image, and the CPU 101 displays the screen in a state where the normal colors button 701 is selected.

In step S505, the CPU 101 displays the screen in the tone based on the readout value. For example, in a case where the readout value is the value indicating “type 1 color vision”, the CPU 101 displays the preview screen 710 that combines a region other than the image display region illustrated in FIG. 7C and the image display region illustrated in FIG. 7F as the preview screen of the “scan and send” application, and ends the processing of the flowchart. In a case where the readout value is the value indicating “type 2 color vision”, the CPU 101 displays the preview screen 710 that combines a region other than the image display region illustrated in FIG. 7D and the image display region illustrated in FIG. 7G, and ends the processing of the flowchart. In a case where the readout value is the value indicating “type 3 color vision”, the CPU 101 displays the preview screen 710 that combines a region other than the image display region illustrated in FIG. 7E and the image display region illustrated in FIG. 7H as the preview screen of the “scan and send” application, and ends the processing of the flowchart. The tone indicating each color vision identical to that of the standard tone setting is maintained as the partial tone setting of the preview image, and the CPU 101 displays a screen in a state where any of the type 1 color vision button 712, the type 2 color vision button 713, and the type 3 color vision button 714 is selected.

### Partial Tone Setting Change Processing

FIG. 9 illustrates an example of a flowchart of partial tone setting processing on the preview screen 710. The processing in the flowchart is started based on an instruction for changing the partial tone setting being accepted in step S601. Each of the subsequent steps in the flowchart is implemented by execution of a program by the CPU 101 in the image processing apparatus 1. The program to be executed is read from the ROM 109 and executed by each functional unit illustrated in FIG. 2. The processing in steps S601 and S603 is similar to the processing in FIG. 6 and thus a description thereof is omitted.

In step S901, the CPU 101 determines which button is pressed by the user. In a case where the CPU 101 determines that the pressed button is the “normal colors button 711” (NORMAL COLORS in step S901), the processing proceeds to step S603. In a case where the CPU 101 determines that the pressed button is the “type 1 color vision button 712” (TYPE 1 COLOR VISION in step S901), the processing proceeds to step S902. In a case where the CPU 101 determines that the pressed button is the “type 2 color vision button 713” (TYPE 2 COLOR VISION in step S901), the processing proceeds to step S903. In a case where the CPU 101 determines that the pressed button is the “type 3 color vision button 714” (TYPE 3 COLOR VISION in step S901), the processing proceeds to step S904.

In step S902, the CPU 101 holds the value indicating “type 1 color vision” as the value (partial tone setting) held by the partial tone setting holding unit 206. Thereafter, the processing proceeds to step S905.

In step S903, the CPU 101 holds the value indicating “type 2 color vision” as the value (partial tone setting) held by the partial tone setting holding unit 206. Thereafter, the processing proceeds to step S905.

In step S904, the CPU 101 holds the value indicating “type 3 color vision” as the value (partial tone setting) held by the partial tone setting holding unit 206. Thereafter, the processing proceeds to step S905.

In step S905, the CPU 101 causes the control unit 202 to update a selection state of each partial tone setting change button based on the partial tone setting held in step S603, S902, S903, or S904. Additionally, the display image generation unit 203 changes the tone of the preview image 343 (353) and displays the preview image 343 (353) in the changed tone on the display unit 201. For example, in a case where the “type 1 color vision button 712” is pressed on the preview screen 710 in FIG. 7B, the CPU 101 holds the value indicating “type 1 color vision” as the partial tone setting in step S902, and the processing proceeds to step S905, the CPU 101 displays the preview screen 710 illustrated in FIG. 7F in step S905. In a case where the “type 2 color vision button 713” is pressed on the preview screen 710 in FIG. 7B, the CPU 101 holds the value indicating “type 2 color vision” as the partial tone setting in step S903, and the processing proceeds to step S905, the CPU 101 displays the preview screen 710 illustrated in FIG. 7G in step S905. In a case where the “type 3 color vision button 714” is pressed on the preview screen 710 in FIG. 7B, the CPU 101 holds the value indicating “type 3 color vision” as the partial tone setting in step S904, and the processing proceeds to step S905, the CPU 101 displays the preview screen 710 illustrated in FIG. 7H in step S905.

In the above-mentioned embodiment, the description has been given of the example in which three or more tone types can be set and changed as tones in the standard tone setting and tones in the partial tone setting. With this configuration, a screen in a tone more specifically corresponding to a type of partial color blindness is displayed, which increases usability.

With this configuration, even in a case where the tone for the partial color blind person is set as the standard tone setting in the MFP, it is possible to easily change the tone of the image display region on the preview screen to the tone for the person with normal color vision, which increases usability for the partial color blind person.

Furthermore, displaying the predetermined items on the predetermined screen makes it possible to change the tone of the image display region to a plurality of different tones while visually recognizing the image display region without transition to another screen, which increases usability.

### Third Embodiment

In the first embodiment, the description has been given of the example of displaying the partial tone setting change buttons (the normal colors button 341 and the reversed colors button 342) on the preview screen 340 (350) even in a case where “normal colors” are set in the standard tone setting. However, there is a conceivable case where the presence of a button that is not normally used by a user with normal color vision within a screen may lead to decreased usability such as erroneous pressing of the button. In a third embodiment, a description will be given of an example in which the partial tone setting change buttons are not included in the preview screen 340 (350) in a case where “normal colors” are set in the standard tone setting.

Since configurations and processing not mentioned herein are equivalent to those of the first embodiment, a description thereof is omitted.

### Operation Screen

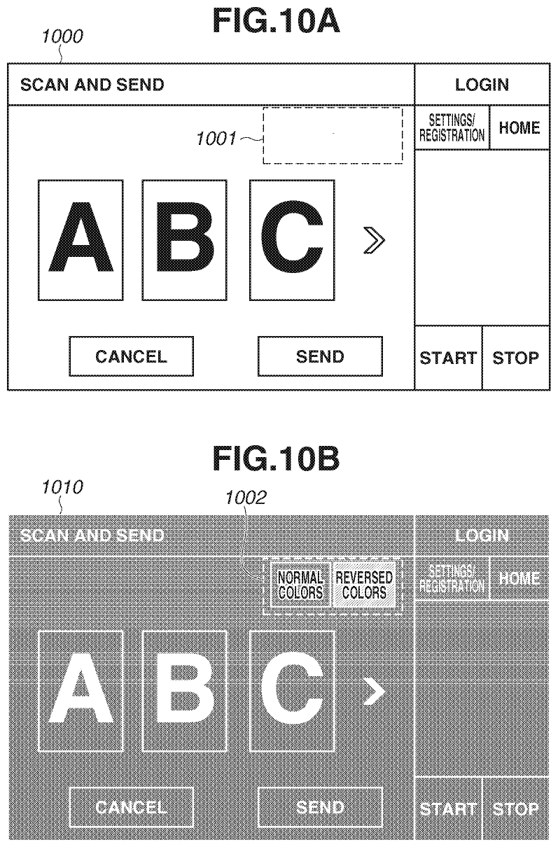

FIGS. 10A and 10B are views each illustrating an example of a screen displayed on the display unit 201 in the image processing apparatus 1.

FIG. 10A is a view illustrating an example of a preview screen 1000 displayed in a case where “normal colors” are set in the standard tone setting. The partial tone setting change buttons are not included in the preview screen 1000 (a broken line 1001 is only for illustrative purposes and is not actually displayed).

FIG. 10B is a view illustrating an example of a preview screen 1010 in a case where “reversed colors” are set in the standard tone setting. The partial tone setting change buttons are included in the preview screen 1010 (a broken line 1002 is only for illustrative purposes and is not actually displayed). Even in a case where the normal colors button 341 is pressed and the preview image is displayed in normal colors, the partial tone setting change buttons remain displayed.

### Screen Display Processing

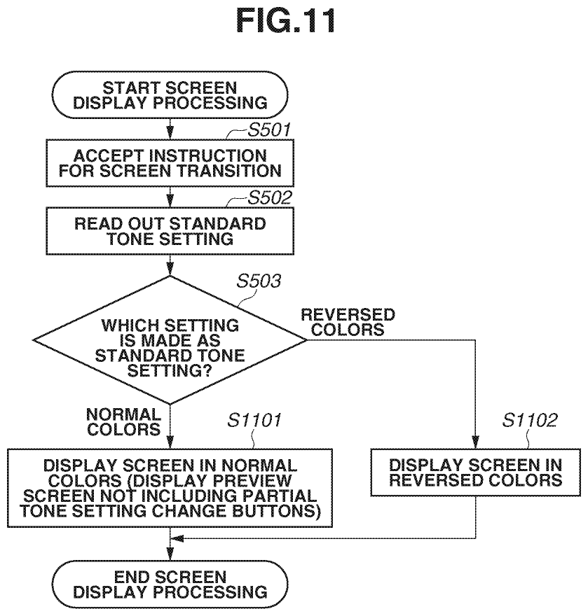

FIG. 11 is a flowchart of screen display processing on each screen. The processing in the flowchart is started based on an instruction for screen transition being accepted in step S501.

Each of the subsequent steps in the flowchart is implemented by execution of a program by the CPU 101 in the image processing apparatus 1. The program to be executed is read from the ROM 109 and executed by each functional unit illustrated in FIG. 2. The processing in steps S501 to S503 is similar to the processing in FIG. 5, and thus a description thereof is omitted.

In step S1101, the CPU 101 displays the screen in “normal colors”, and ends the processing in the flowchart. For example, in a case of a preview screen of the “scan and send” application, the CPU 101 displays the preview screen 1000 that is illustrated in FIG. 10A and that does not include the partial tone setting change buttons.

In step S1102, the CPU 101 displays the screen in “reversed colors”, and ends the processing in the flowchart. For example, in a case of a preview screen of the “scan and send” application, the CPU 101 displays the preview screen 1010 that is illustrated in FIG. 10B and that includes the partial tone setting change buttons.

In the above-mentioned embodiment, the description has been given of the example in which the partial tone setting change buttons are not included in the preview screen 340 (350) in a case where “normal colors” are set in the standard tone setting. This can lessen the decrease of usability due to display of the screen including buttons that are bothersome to the user with normal color vision.

### Fourth Embodiment

In the first to third embodiments, the description has been given of the configuration in which changing the partial tone setting changes the tone of the image display region (the region in which the preview image is displayed). However, there is a conceivable case where a contour with respect to a background color becomes ambiguous depending on contents of the preview image and visibility deteriorates. In a fourth embodiment, a description will be given of a configuration in which changing the partial tone setting changes a tone of the image display region and a tone of a region including the background region in the periphery of the image display region.

Since configurations and processing not mentioned below are equivalent to those of the first embodiment, a description thereof is omitted.

### Operation Screen

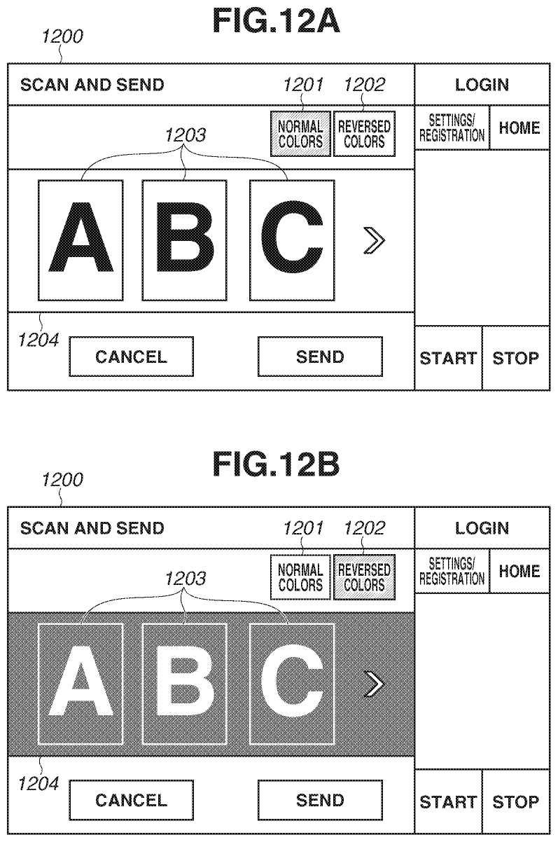

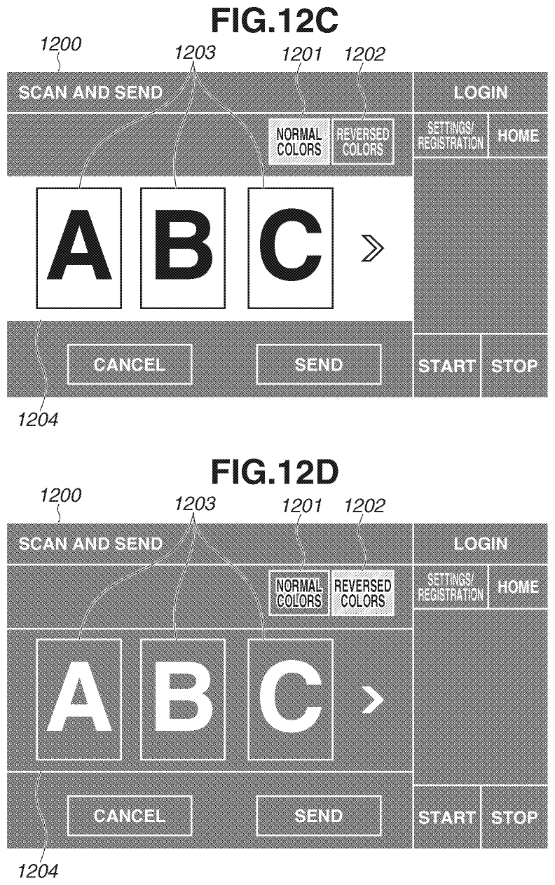

FIGS. 12A to 12D are views each illustrating an example of a screen displayed on the display unit 201 in the image processing apparatus 1.

FIG. 12A is a view illustrating an example of a preview screen 1200 displayed in a case where “normal colors” are set in the standard tone setting and the partial tone setting. FIG. 12B is a view illustrating an example of the preview screen 1200 displayed in a case where “normal colors” are set in the standard tone setting and “reversed colors” are set in the partial tone setting. FIG. 12C is a view illustrating an example of the preview screen 1200 displayed in a case where “reversed colors” are set in the standard tone setting and “normal colors” are set in the partial tone setting. FIG. 12D is a view illustrating an example of the preview screen 1200 displayed in a case where “reversed colors” are set in the standard tone setting and the partial tone setting. Partial tone setting change buttons (a normal colors button 1201 and a reversed colors button 1202), a preview image 1203, and a background region 1204 are disposed on the preview screen 1200.

When the normal colors button 1201 or the reversed colors button 1202 is pressed, a tone of the preview image 1203 is changed in accordance with the flowchart in FIG. 6. In step S605, the CPU 101 causes the control unit 202 to update a selection state of each partial tone setting change button based on the partial tone setting held in step S603 or S604. The display image generation unit 203 then changes the tone of the preview image 1203 and the tone of the background region 1204, and displays the preview image 1203 and the background region 1204 in the changed tones on the display unit 201. For example, in a case where the “reversed colors button 1202” is pressed on the preview screen 1200 in FIG. 12A, the CPU 101 holds “reversed colors” as the partial tone setting in step S604, and the processing proceeds to step S605, the CPU 101 displays the preview screen 1200 illustrated in FIG. 12B in step S605. In a case where the “normal colors button 1201” is pressed on the preview screen 340 in FIG. 12B, the CPU 101 holds “normal colors” as the partial tone setting in step S603, and the processing proceeds to step S605, the CPU 101 displays the preview screen 1200 illustrated in FIG. 12A in step S605. Similarly, in a case where the “reversed colors button 1202” is pressed on the preview screen 1200 in FIG. 12C, the CPU 101 holds “reversed colors” as the partial tone setting in step S604, and the processing proceeds to step S605, the CPU 101 displays the preview screen 1200 illustrated in FIG. 12D in step S605. In a case where the “normal colors button 1201” is pressed on the preview screen 1200 in FIG. 12D, the CPU 101 holds “normal colors” as the partial tone setting in step S603, and the processing proceeds to step S605, the CPU 101 displays the preview screen 1200 illustrated in FIG. 12C in step S605. Thereafter, the CPU 101 ends the processing in the flowchart in FIG. 6.

In the present embodiment, the above description has been given of the configuration in which changing the partial tone setting changes the tone of the image display region and the tone of the region including the background region in the periphery of the image display region. This configuration makes it possible to prevent the contour between the content of the preview image and the background color from becoming ambiguous and lessen deterioration of visibility.

In the present embodiment, the background region 1204 is expressed as part of the whole screen, but is not limited thereto. Specifically, the background region 1204 may include the whole screen.

However, there is a possibility that changing the partial tone setting with respect to the whole screen makes it difficult to see other operation buttons (for example, a cancel button and a send button). Hence, it is favorable to employ a configuration in which an operation button group, a text part in a case of text display, and the like are not changed in tone by the partial tone setting change processing.

This can increase usability regarding screen display.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-057895, filed Mar. 31, 2025, which is hereby incorporated by reference herein in its entirety.

What is claimed is:

1. An image processing apparatus comprising:
a display control unit configured to display a predetermined screen including an image display region in which image data is displayed, an operation region in which processing is executed on the image data, and a predetermined item to execute processing of changing a tone of the image display region,
wherein the display control unit is configured to, based on the predetermined item being operated, change the tone of the image display region and display the image display region in the changed tone.

2. The image processing apparatus according to claim 1, wherein, in a case where the predetermined item is operated, the operation region is displayed without a change of a tone of the operation region.

3. The image processing apparatus according to claim 1, wherein the display control unit is configured to, based on the predetermined item being operated, change the tone of the image display region from a tone for a person with normal color vision to a tone for a partial color blind person and display the image display region in the changed tone, or change the tone of the image display region from the tone for the partial color blind person to the tone for the person with normal color vision and display the image display region in the changed tone.

4. The image processing apparatus according to claim 1, further comprising a setting unit configured to set a first mode to display information to be displayed on a display unit in the image processing apparatus in a tone for a person with normal color vision and a second mode to display information to be displayed on the display unit in a tone for a partial color blind person.

5. The image processing apparatus according to claim 4, wherein the display control unit is configured to, based on the second mode being set and the predetermined item being operated, change the tone of the image display region from the tone for the partial color blind person to the tone for the person with normal color vision and display the image display region in the changed tone.

6. The image processing apparatus according to claim 4, wherein, in a case where the first mode is set, the predetermined item is not displayed on the predetermined screen.

7. The image processing apparatus according to claim 1, wherein the display control unit is configured to, based on the predetermined item being operated, change the tone of the image display region and a tone of a region that surrounds the image display region and that is different from both the image display region and the operation region, and display the image display region and the region in the changed tones.

8. The image processing apparatus according to claim 1, wherein the display control unit is configured to display a plurality of the predetermined items.

9. The image processing apparatus according to claim 8, wherein the plurality of items is items that allow for a change of the tone of the image display region to a tone of a different type for a partial color blind person.

10. A control method comprising:
performing display control to display a predetermined screen including an image display region in which image data is displayed, an operation region in which processing is executed on the image data, and a predetermined item to execute processing of changing a tone of the image display region,
wherein the display control includes, based on the predetermined item being operated, changing the tone of the image display region and displaying the image display region in the changed tone.

11. A non-transitory computer-readable storage medium storing a program that causes a computer to execute a control method comprising:
performing display control to display a predetermined screen including an image display region in which image data is displayed, an operation region in which processing is executed on the image data, and a predetermined item to execute processing of changing a tone of the image display region,
wherein the display control includes, based on the predetermined item being operated, changing the tone of the image display region and displaying the image display region in the changed tone.
